(19) United States
(12) Patent Application Publication
(10) Pub. No.: US 2016/0283994 A1
(43) Pub. Date: Sep. 29, 2016

(54) TRUST CALCULATOR FOR PEER-TO-PEER TRANSACTIONS

(71) Applicant: International Business Machines Corporation, Armonk, NY (US)

(72) Inventors: Jeffrey L. Edgington, Keller, TX (US); Hung T. Kwan, Grand Prairie, TX (US); Shiju Mathai, Carroliton, TX (US)

(21) Appl. No.: 14/668,164

(22) Filed: Mar. 25, 2015

(51) Int. Cl. G06Q 30/06; G06Q 50/30; G06Q 30/00; H04L 29/08; G06F 17/30

(52) U.S. Cl. CPC G06Q 30/0609; H04L 67/104; G06F 17/3053; G06F 17/30241; G06F 17/30867; G06F 17/3087; G06Q 30/018; G06Q 50/30

(57) ABSTRACT

A system, method and program product that evaluates trustworthiness of nodes participating in peer-to-peer transactions. A system is disclosed that includes: an input process for receiving a resource request from a consumer node; an identification analyzer that collects metadata associated with the consumer node; a transaction analyzer that extracts contextual data associated with the resource request; a matching engine that matches the consumer node with a set of provider nodes; and a contextual trust scoring engine that calculates a trust score for each of the consumer node and the set of provider nodes, wherein the trust score is based on the request, the metadata, and the contextual data.

### TECHNICAL FIELD

The subject matter of this invention relates to peer-to-peer environments, and more particularly to matching providers and consumers in a peer-to-peer networking environment based on contextual information.

### BACKGROUND

Peer-to-peer type platforms are often used as a means for delivering resources from provider nodes to consumer nodes. In such an environment, both provider and consumer nodes may for example be implemented with an application, e.g., a Mobile App, that allows a consumer node to search and engage provider nodes capable of fulfilling a requested resource.

While it is relatively straightforward to identify and provide quantitative capabilities of provider nodes (e.g., cost and availability), it is much more challenging to identify provider nodes that meet qualitative requirements of a given consumer node.

One existing approach is to pre-vet both consumer and provider nodes to ensure credentials and compliance standards are met. A further approach is to rate and/or rank consumer and provider nodes within a peer-to-peer environment. Unfortunately, such approaches are often static in nature, but more importantly do not take into account the context in which a particular service or resource is to be provided.

### SUMMARY

The present disclosure describes a trust system and method that utilizes contextual information to provide trustworthiness data for participants of peer-to-peer transactions.

A first aspect provides a trust system that evaluates trustworthiness of nodes participating in peer-to-peer transactions, comprising: an input process for receiving a resource request from a consumer node; an identification analyzer that collects metadata associated with the consumer node; a transaction analyzer that extracts contextual data associated with the resource request; a matching engine that matches the consumer node with a set of provider nodes; and a contextual trust scoring engine that calculates a trust score for each of the consumer node and the set of provider nodes, wherein the trust score is based on the request, the metadata, and the contextual data.

A second aspect provides a computer program product stored on a computer readable storage medium, which when executed by a computing system, evaluates trustworthiness of nodes participating in peer-to-peer transactions, comprising: program code for receiving a resource request from a consumer node; program code that collects metadata associated with the consumer node; program code that extracts contextual data associated with the resource request; program code that matches the consumer node with a set of provider nodes; and program code that calculates a trust score for each of the consumer node and the set of provider nodes, wherein the trust score is based on the request, the metadata, and the contextual data.

A third aspect provides a method for evaluating trustworthiness of nodes participating in a peer-to-peer environment, comprising: receiving a resource request from a consumer node; collecting metadata associated with the consumer node; extracting contextual data associated with the resource request; matching the consumer node with a set of provider nodes; and calculating a trust score for each of the consumer node and the set of provider nodes, wherein the trust score is based on the request, the metadata, and the contextual data.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a trust system according to embodiments.

FIG. 2 shows a process flow for implementing the trust system according to embodiments.

FIG. 3 shows a consumer interface according to embodiments.

FIG. 4 shows a provider interface according to embodiments.

FIG. 5 shows a matching engine flow according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

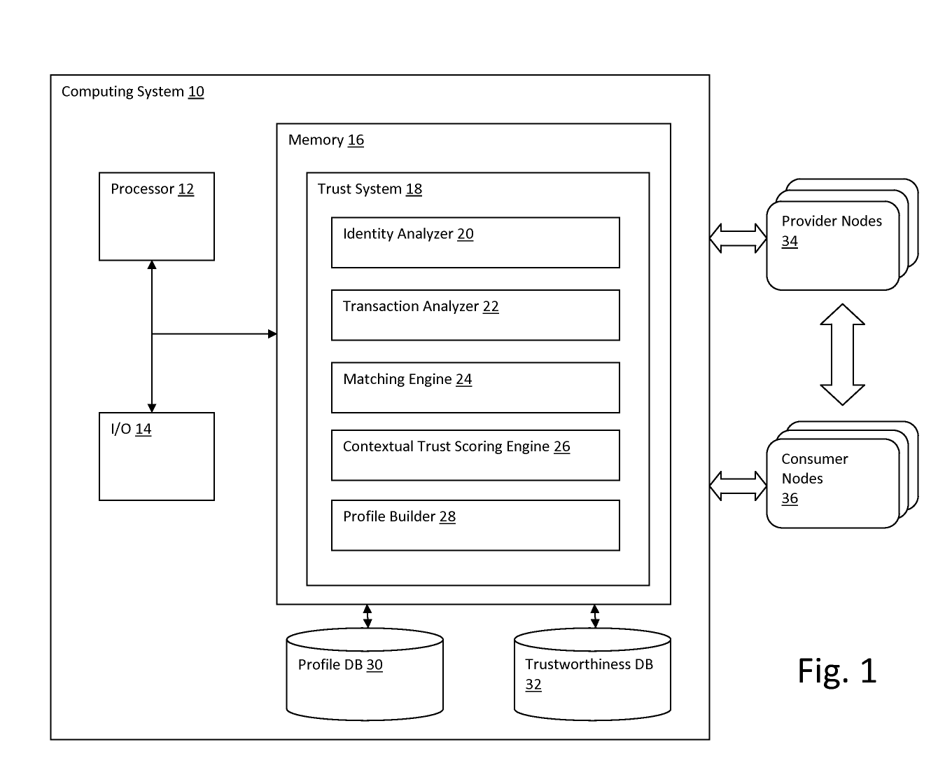

Referring now to the drawings, FIG. 1 depicts a computing system 10 for implementing a trust system 18 for a peer-to-peer environment involving provider nodes 34 and consumer nodes 36. For the purposes of this disclosure, the term peer-to-peer environment generally refers to any platform that facilitates the provisioning of resources directly between provider nodes 34 and consumer nodes 36. Accordingly, computing system 10 may comprise a distributed computing infrastructure that facilitates a pure peer-to-peer computing infrastructures, a hybrid peer-to-peer computing infrastructure, or any other capable computing infrastructure. In an illustrative embodiment, provider nodes 34 and consumer nodes 36 may be implemented on mobile devices as downloadable Apps.

Trust system 18 may be utilized to enhance the provisioning of any type of resources by provider nodes 34 for consumer nodes 36, including, e.g., computing resources, data resources, social media based services, transportation services, transactional services, the sale of miscellaneous goods and services, etc. In some cases, resources may be provided and implemented in an automated fashion (e.g., using agents in a cloud computing or networking infrastructure), in a manual fashion involving human interaction (e.g., providing taxi services such as with UBER®), or in a semi-automated fashion (e.g., where some automation and some human intervention is required).

Regardless of the nature of the resources provided, trust system 18 provides a mechanism for allowing both provider nodes 34 and consumer nodes 36 to more effectively evaluate other participants (i.e., nodes) when entering into a potential transaction. In particular, trust system 18 utilizes contextual information about the parties and the transaction to better assess and match provider nodes 34 and consumer nodes 36.

Generally, trust system 18 includes: an input process for receiving resource requests, an identity analyzer 20 that evaluates potential participants to a transaction; a transaction analyzer 22 that determines contextual information about a potential transaction; a matching engine 24 that matches a consumer node 36 to a set of potential provider nodes 34 for a desired transaction; contextual trust scoring engine 26 that generates trust data for participants based on contextual information and stores the trust data in a trustworthiness database (DB) 32; and a profile builder that collects participant and transaction information in a profile database 30.

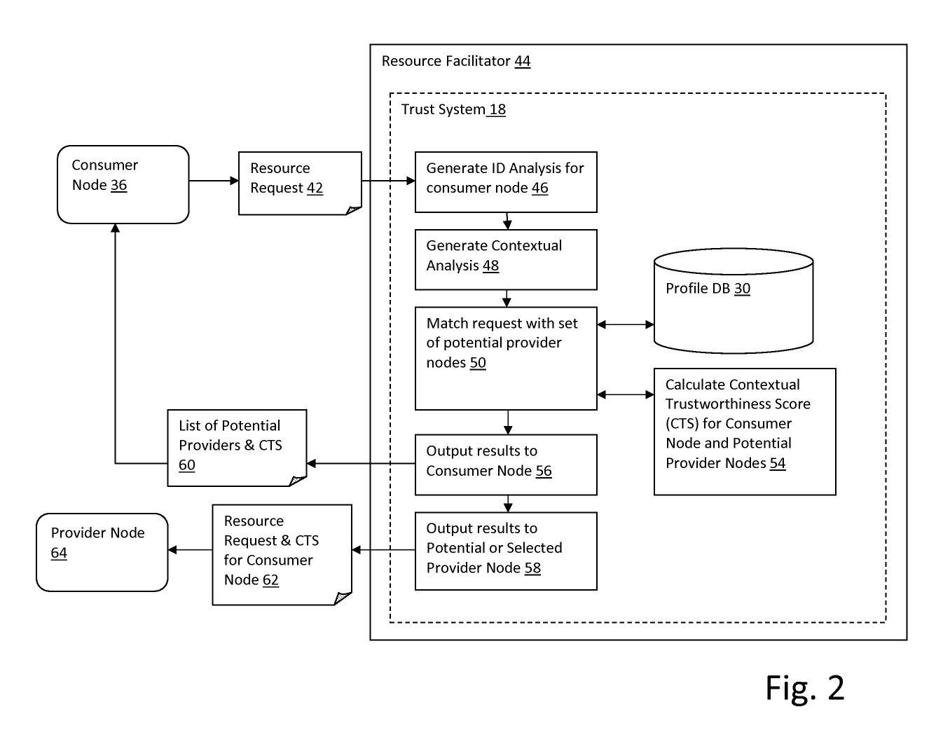

FIG. 2 depicts a flow diagram showing an illustrative process for implementing trust system 18. In this example, consumer node 36 submits a resource request 42 to a resource facilitator 44 that has incorporated trust system 18. Resource facilitator 44 may comprise any type of platform for facilitating a peer-to-peer environment in which a consumer node 36 seeks to find and engage a provider node 64 to fulfill a needed resource. For example, consumer node 36 may comprise a person interfacing with a mobile App seeking to hire a taxi driver, such as that provided by UBER. Accordingly, in such a case, resource request 42 may include the name or user ID of the person, current location, desired destination, and special requirements.

Resource request 42 may comprise any and all necessary information to provision the resource. For example, in the case of a taxi service, the request may be implemented as follows:

<Request>=1001
<User ID>=Jane Doe
<Pickup>=location 111
<Dropoff>=location 222
<Time>=ASAP
<Special Requirements>
   <Number passengers>=4

Once inputted, resource request 42 is processed by the trust system 18, which first generates an ID analysis 46 for the consumer node 40 using identity analyzer 20 (FIG. 1). Identity analyzer 20 generally comprises any mechanism for collecting and analyzing metadata about participants to a transaction. For example, in the case where the participants are people, identity analyzer 20 may include sub-processes for:

(1) Validating professional credential, including, e.g., licenses, certifications, degrees; length of service associated with professional credentials; profession-related reviews, ratings, and/or citations; and services provided by the person;

(2) Analyzing relationships, including, e.g., identify associations related with the participant;

(3) Performing social network data analysis, including, e.g., evaluating real-time and/or historic social media data, examining social networking relationships, etc.;

(4) Performing public record searches, to, e.g., identify criminal history, lawsuits, etc., associated with the participant; and

(5) Other background checking sources, e.g., reviewing forums relevant to the profession, publications by or about the participant (including resume, bio, etc), and property and business listings associated with participant, etc.

One potential output of the identity analyzer 20 is a set of metadata and potentially quantitative scores that measure strengths/weaknesses of the participant on a 0-10 scale. For instance, the output may be as follows:

<Professional Credentials>=Licensed in NYS
<Years Experience>=5.6
<Score>=8

<Relationships>
<Professional Associations>=0
<Score>=2

<Social Network>=Active
<Followers>=508
<Score>=7

<Legal Issues>=none
<Score.=10

<Other Factors>=n/a

For the consumer node 36, identity analyzer 20 may perform the analysis in real time, e.g., when a consumer node 36 submits a resource request 42. Alternatively, for a repeat consumer, the analysis may be stored, retrieved and updated as needed from the profile database 30. For service providers (i.e., provider node 64), the analysis may be pre-computed, e.g., when the provider node 64 registers with the service, which can then be updated periodically.

Next, a contextual analysis 48 is generated by the transaction analyzer 22 (FIG. 1), which examines elements of the resource request 42 and associated conditions to collect contextual information. Contextual information may for example include location information, environmental conditions, time information, etc. In the case of a taxi request, contextual analysis 48 may thus for example extract: (1) location particulars, e.g., the pick-up location is an airport and the drop-off location is a suburb; (2) the nature of the requestor, e.g., a female traveling with young children and a large amount of luggage; (3) weather conditions, e.g., dark and raining; (4) traffic conditions, e.g., there is a heavy amount of traffic in along the preferred route; (5) ongoing events or incidents potentially impacting the request; and (6) timing and scheduling demands.

Furthermore, a location analysis may be performed by the transaction analyzer 22 that determines current and historical data (e.g., crime, incidents, demographics, etc.) for areas associated with the request; optimal routes, etc. The following is an illustrative record of contextual data:

<Transaction>=1234
<Weather>=cold and raining
<Neighborhood>=high risk

Next the resource request 42, ID analysis 46 and contextual analysis 48 are fed into the matching engine 24 (FIG. 1) to match 50 the request 42 with a set of potential provider nodes 34 from the profile database 30. As part of the process, a contextual trustworthiness score (CTS) 54 is calculated for both the consumer node 36 and set of potential provider nodes by the contextual trust scoring engine 24 (FIG. 1). CTS takes into account the context of the transaction to better match the consumer node 36 with potential providers in the provider database 30. For example, because it is snowing, a driver with a four wheel drive SUV may have a higher CTS than one without. Further, a more experienced driver with a clean driving record may have a higher CTS than a younger driver with multiple traffic infractions when taxiing a family with multiple small children. It should also be noted that the resource request 42 (or ID analysis 46) may include special requirements of the consumer node 36 that can be taken into account in the CTS, e.g., the requestor prefers a female driver, prefers a driver who can most quickly fulfill the request, etc.

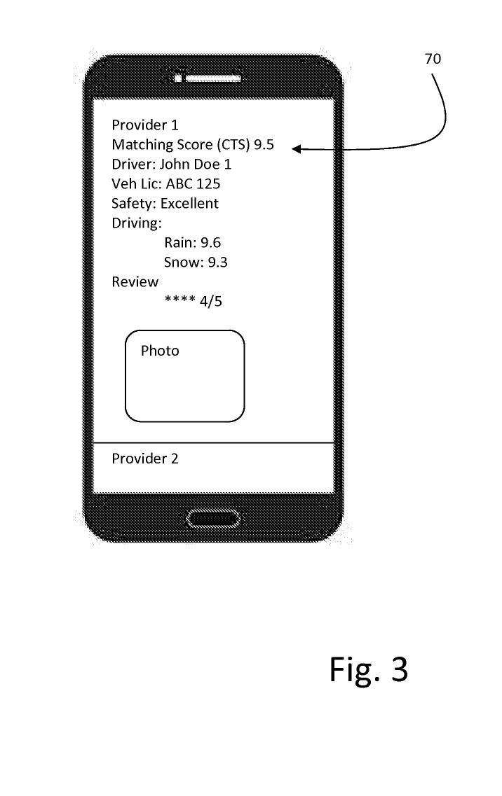

Next, the results 60 are outputted 56 to the consumer node 36, who can then decide on a provider node 64 to fulfill the request. The results 60 may for example include a list of potential providers and the associated CTS for each. An example is shown if FIG. 3. In this example, a matching score (i.e., CTS) 70 is provided as 9.5 which gives an overall strength of the contextual match. Additional information such as safety ratings, reviews, etc., can be provided as well.

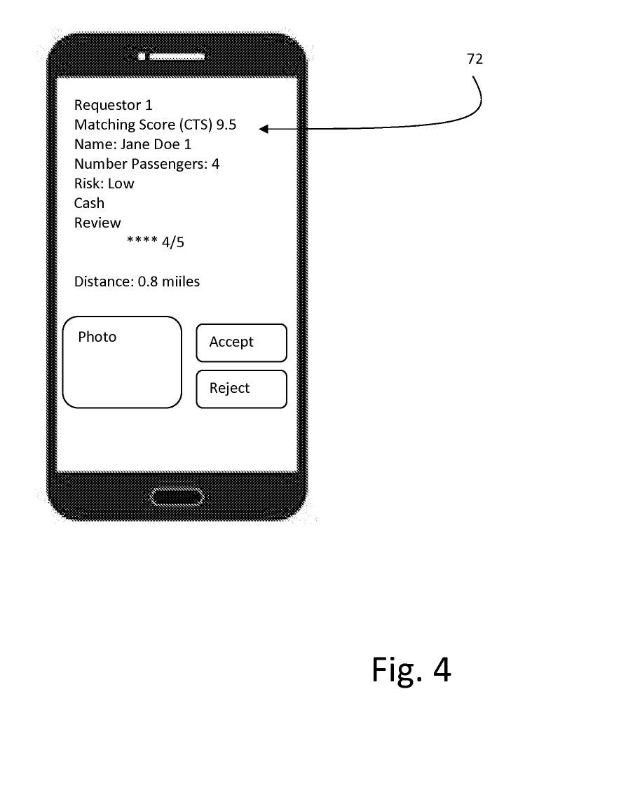

Similar results are outputted 58 to potential or selected provider nodes, who can use the results to determine if they want to fulfill the request. The results 62 include details of the resource request and CTS for the consumer node. An example is shown in FIG. 4, which includes the matching score (i.e., CTS) 72 as well as additional information such as risk, payment type, etc.

Referring again to FIG. 1, a profile builder 28 may be utilized to populate the profile database 30. Relevant information in the above example may include: demographics, contact info, and preferences including situational preferences (e.g., daytime/nighttime/rain requirements). Also included may be acceptance criteria for service requests, driving record, notification preferences, schedule preferences, service history, services requested or provided, ratings of previous interactions, and data learned from identity analyzer 22 (which is periodically updated). Further information may include profession, skills, background/search results, default location, other details, travel itinerary and additional skills held.

The trustworthiness database 32 may include ratings, i.e., CTS/Rankings for each user based on analysis from contextual trust scoring engine 26; overall trust scores in general (any criminal/legal complaints); trust scores for previous found matching engine correlations; trust score for instances of service requests, etc.

Accordingly, the trust system 18 allows participants engaging in a peer-to-peer transaction to evaluate and mitigate risks. In particular, a trustability solution is provided that supplies contextual analysis in real-time between resource providers and consumers to match the best possible provider for the given situation, taking into account real-time information to validate/verify all the parties involved. This way, both consumer and provider can benefit.

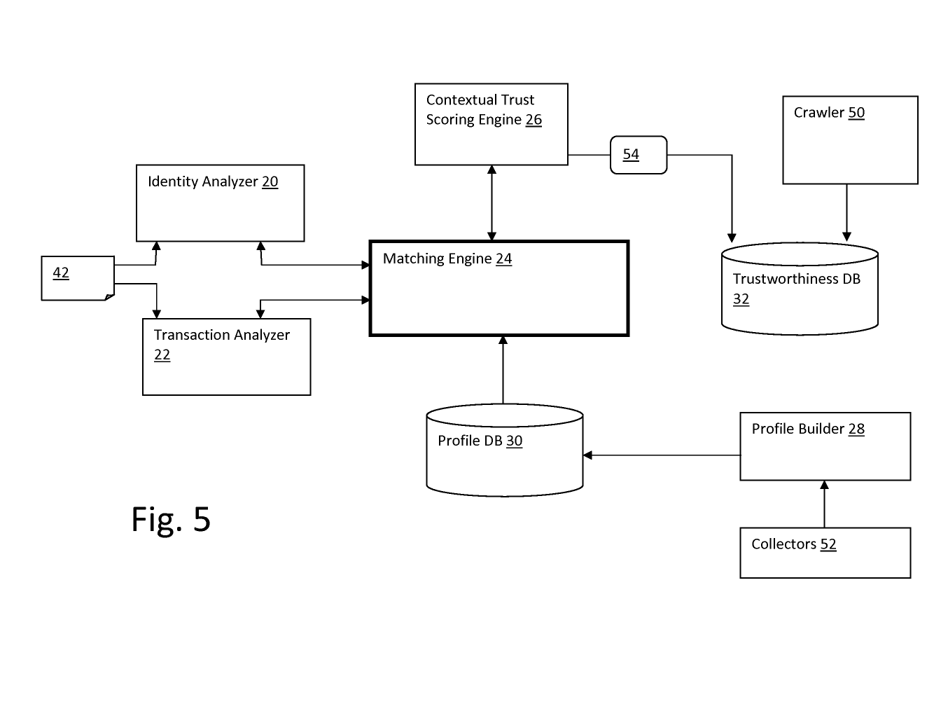

FIG. 5 depicts an overview of how the matching engine 24 matches consumers with providers and utilizes a trust score (CTS) 54. Any process for matching consumer nodes with provider nodes may be used. When a request 42 comes in, identity analyzer 20 forwards an identity analysis to the matching engine 24 and transaction analyzer 22 forwards a contextual analysis to the matching engine 24. Matching engine 24 then pulls potential provider matches from the profile database 30, based, e.g., on the context of service request, neighborhood analysis, availability of resources in the locations, skill requirements needed to fulfill the request, demographics and/or cultural needs of both the requester and provider, availability and schedule, etc.

Contextual trust scoring engine 26 is utilized to generate the trust score 54. Context scoring may be based on experiences, rating history, user preferences, peer activity, location, availability of provider, specific requirements of the requester/profile, weather, cultural and demographic information, local events in neighborhood, skills/ratings, etc.

In addition to outputting trust scores 54 to the participants, scores 54 and other data are also saved to the trustworthiness database 32. Namely, trust scores, rankings, etc., for each participant are stored along with other relevant details, e.g., any criminal/legal complaints, trust scores for previous matching engine correlations, trust scores for all instances of fulfilled requests, etc. A crawler 50 may be utilized to dynamically crawl for new sources of information to update the identity analyzer 20 and profile database 30.

Profile builder 28 may utilize a set of collectors that discover and build new profiles based on analysis, and send invites to potential clients to join the peer network, etc. For example, as new consumers enter a neighborhood or zone, analysis may be performed and an invitation may be sent.

Accordingly, trustworthiness is provided with a score for trust and resource location/verification to determine reliability using context, real-time information, historical data and social media interaction. The present approach considers context awareness factors (e.g., weather, location, neighborhood analysis, who is nearby, who has experience driving in bad rain, who is familiar with this part of town, etc.). Thus, if a consumer is in a bad part of town, they can find a driver who has prior experience in law enforcement or is trained in martial arts, carries a concealed weapon, etc. Further, the trust score validates identity, whether the other party is trustworthy, whether it is a good fit, and whether the fit is timely.

As noted above, the trust system 18 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computing system 10 that may comprise any type of computing device and, and for example includes at least one processor 12, memory 16, an input/output (I/O) 14 (e.g., one or more I/O interfaces and/or devices), and a communications pathway. In general, processor(s) 12 execute program code which is at least partially fixed in memory 16. While executing program code, processor(s) 12 can process data, which can result in reading and/or writing transformed data from/to memory and/or I/O 14 for further processing. The pathway provides a communications link between each of the components in computing system 10. I/O 14 can comprise one or more human I/O devices, which enable a user to interact with computing system 10.

Furthermore, it is understood that the trust system 18 or relevant components thereof (such as an API component) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will, select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A trust system that evaluates trustworthiness of nodes participating in peer-to-peer transactions, comprising:
an input process for receiving a resource request from a consumer node;
an identification analyzer that collects metadata associated with the consumer node;
a transaction analyzer that extracts contextual data associated with the resource request;
a matching engine that matches the consumer node with a set of provider nodes; and
a contextual trust scoring engine that calculates a trust score for each of the consumer node and the set of provider nodes, wherein the trust score is based on the request, the metadata, and the contextual data.

2. The trust system of claim 1, wherein the metadata includes: credential verification, relationship analysis, social network data analysis, and public record search results.

3. The trust system of claim 1, wherein the contextual data includes: a location analysis, an environment analysis, and a time analysis.

4. The trust system of claim 1, wherein the matching engine utilizes the trust score to rank the set of provider nodes.

5. The trust system of claim 1, wherein the resource request comprises a request for transportation services, and the contextual data includes a neighborhood analysis.

6. The trust system of claim 1, wherein the identity analyzer collects and stores metadata associated with registered provider nodes.

7. The trust system of claim 6, further comprising a crawler that periodically updates the metadata associated with registered provider nodes.

8. A computer program product stored on a computer readable storage medium, which when executed by a computing system, evaluates trustworthiness of nodes participating in peer-to-peer transactions, comprising:
program code for receiving a resource request from a consumer node;
program code that collects metadata associated with the consumer node;
program code that extracts contextual data associated with the resource request;
program code that matches the consumer node with a set of provider nodes; and
program code that calculates a trust score for each of the consumer node and the set of provider nodes, wherein the trust score is based on the request, the metadata, and the contextual data.

9. The program product of claim 8, wherein the metadata includes at least one of:
credential verification, relationship analysis, social network data analysis, and public record search results.

10. The program product of claim 8, wherein the contextual data includes at least one of:
a location analysis, an environment analysis, and a time analysis.

11. The program product of claim 8, wherein matching consumer node with a set of provider nodes utilizes the trust score to rank the set of provider nodes.

12. The program product of claim 8, wherein the resource request comprises a request for transportation services, and the contextual data includes a neighborhood analysis.

13. The program product of claim 8, further comprising program code that collects and stores metadata associated with registered provider nodes.

14. The program product of claim 13, further comprising program code that periodically updates the metadata associated with registered provider nodes.

15. A method for evaluating trustworthiness of nodes participating in a peer-to-peer environment, comprising:
receiving a resource request from a consumer node;
collecting metadata associated with the consumer node;
extracting contextual data associated with the resource request;
matching the consumer node with a set of provider nodes; and
calculating a trust score for each of the consumer node and the set of provider nodes, wherein the trust score is based on the request, the metadata, and the contextual data.

16. The method of claim 15, wherein the metadata includes at least one of: credential verification, relationship analysis, social network data analysis, and public record search results.

17. The method of claim 15, wherein the contextual data includes at least one of: a location analysis, an environment analysis, and a time analysis.

18. The method of claim 15, wherein matching consumer node with a set of provider nodes utilizes the trust score to rank the set of provider nodes.

19. The method of claim 15, wherein the resource request comprises a request for transportation services, and the contextual data includes a neighborhood analysis.

20. The method of claim 15, further comprising program code that collects and stores metadata associated with registered provider nodes.
